(19) United States
(12) Patent Application Publication
(10) Pub. No.: US 2010/0011631 A1
(43) Pub. Date: Jan. 21, 2010

(54) DECORATIVE DISPLAY DEVICE

(76) Inventor: JOHN E. THOMPSON, SPIRIT LAKE, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 12/506,884

(22) Filed: Jul. 21, 2009

Related U.S. Application Data
(60) Provisional application No. 61/082,359, filed on Jul. 21, 2008.

(51) Int. Cl. A47G 1/12; G09F 5/00; G09F 19/00

(52) U.S. Cl. 40/1

(57) ABSTRACT

Described herein is an apparatus for display or storage. The apparatus comprises two parts; a first part being a base to indicate an actual object and a second part being a display window atop the base, the display window showing an indicator related to the object indicated by the shape of the base.

### CROSS-REFERENCE TO RELATED APPLICATIONS

This application claims priority under 35 U.S.C. §119 of a provisional application Ser. No. 61/082,359 filed Jul. 21, 2008, which application is hereby incorporated by reference in its entirety.

### BACKGROUND OF THE INVENTION

1. Field of the Invention

The present invention relates to an apparatus for displaying indicia or graphics in a manner which promotes convenient viewing and display.

2. Related Art

Symbols or indicia can be displayed in a variety of ways. For example, flags can be mounted on flag poles, hung from hangers, or mounted framed. Flags, guns, cannons, swords, or other Civil War items are examples of items or symbols or indicia of a specific era or subject matter which might be desirable to display. Similarly, other items of different subject matter, eras, or types can be desirable to be displayed, or indicia or symbols related to such subject matter. Sometimes groupings or collections of items are mounted for display. However, full-sized, functional versions of symbols such as flags tend to be large and somewhat unwieldy.

Therefore, many times such symbols are presented in miniature or reduced scale size. Small scale sized flags, for example, can be made of fabric or material which simulates actual flag fabric, brass, aluminum or metal stampings. However, such material does not tend to very robust. It is also difficult to mount or frame the same in a manner which is convenient to view.

### BRIEF SUMMARY OF THE INVENTION

The present invention relates to a decorative display for indicia or symbols. A base includes a bottom for placement on a surface. An intermediate portion extends upwardly to a top. The top can be angled in a direction to present convenient viewing of the top area on the base. Indicia, such as a symbol, can be imprinted or mounted on a carrier layer or plate that can be mounted on top of the base. A frame can mount over the carrier or plate with the image to hold it in place on top of the base and frame the image. Optionally the frame can itself include indicia. One example is by engravement or embossment.

In one aspect of the invention, the base can be configured to simulate or evoke an actual item or thing. For example, the base can be configured to simulate or evoke an actual object that may be related to the indicia or symbol displayed on top of it.

### BRIEF DESCRIPTION OF THE DRAWINGS

FIGS. 1A-C are pictures of an exemplary embodiment of the present invention from different view points. Each of FIGS. 1A-C shows the apparatus in assembled form with examples of indicia for display on top of the base as well as indicia on the base.

FIG. 2 is an alternative embodiment in exploded view.

### DETAILED DESCRIPTION OF EXEMPLARY EMBODIMENT

### Overview

A specific exemplary embodiment of the invention will now be described in detail to assist in an understanding of the invention. Reference numbers will be used to indicate certain parts and locations in the figures. The same reference numerals will be used to indicate the same parts and locations throughout the figures unless otherwise indicated.

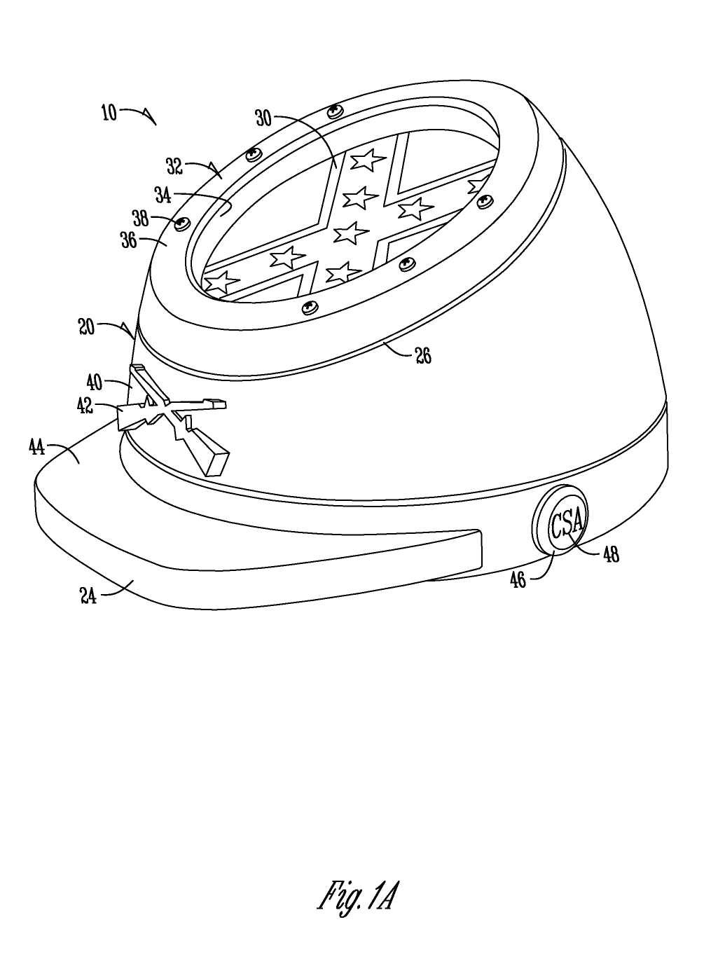

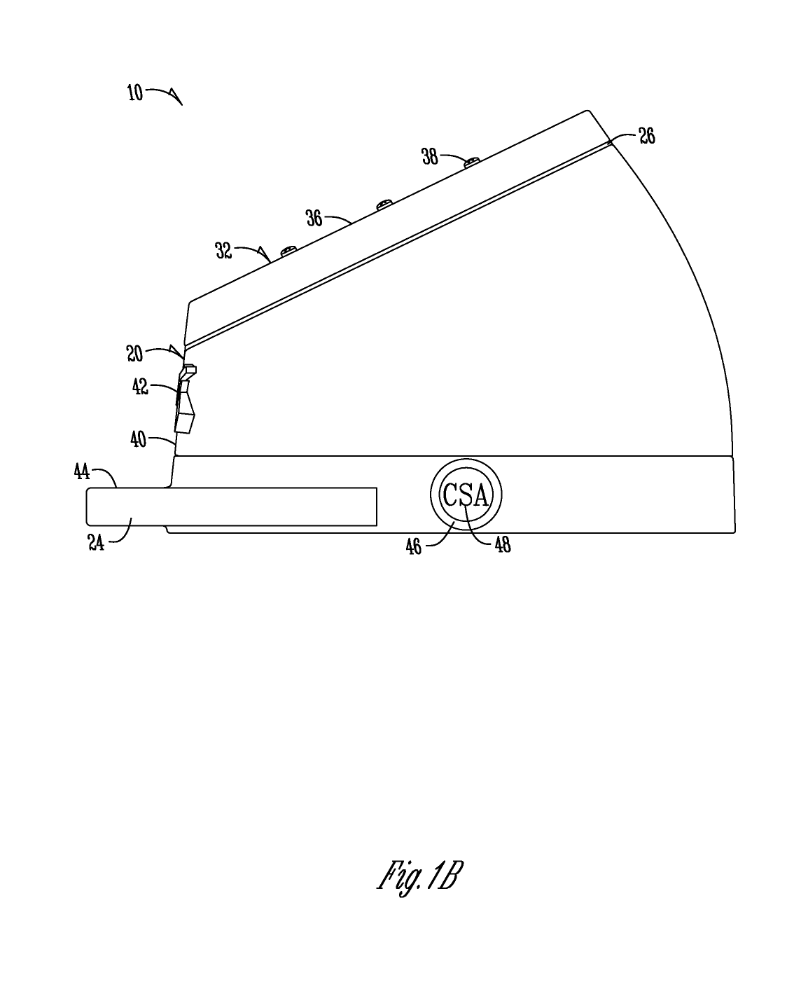

The context of the exemplary embodiment is a base simulating an actual object of the Civil War era. The indicia displayed on top of the base is a symbol from the Civil War era. It is to be understood, however, that this is but one non-limiting example of the shape of the base and the symbol displayed on the base that are possible. FIGS. 1A-C and 2 simply show a single example, for illustration purposes.

### Exemplary Embodiment

The decorative display apparatus in the figures is indicated generally at reference numeral 10. Apparatus 10 includes a base 20 with a displayed image or indicia 30 on top of the base.

As can be seen in FIGS. 1A-C, in this example base 20 is intentionally formed in a simulated shape to evoke the three-dimensional image of a Civil War era object. In this example it is a kepi hat. A kepi hat is a cap with flat circular top and a visor. It is typical of those worn by some Civil War era soldiers (either South or North). Bottom 24 of base 20 includes portion 44 which simulates the kepi hat visor and headband. Intermediate portion 40 simulates the main portion of the kepi hat. Portions 24, 40, and 44 can, for example, be made of die-cast A-380 aluminum with black high gloss powder coat paint applied. Top 26 of base 20 presents a generally flat and roughly circular top. Note, however, that top 26 of base 20 is in a plane which is generally oblique to the plane of the bottom 24 of base 20. This is more conducive and promotes easier viewing of the indicia 30 displayed on top of base 20 when, for example, apparatus 10 is sitting on a table top or shelf. This oblique angle can vary but is generally illustrated in one form in the FIGS. 1A-C.

In this specific embodiment, the interior of base 20 (e.g. A-380 aluminum with powder coat grey high gloss paint) can occupy on the order of a minimum of 210 cubic inches of volume. Bottom 24 of base 20 can be closed off. Alternatively, the entire base 20 can be made of solid material. Still further, the interior of base 20, can be substantially hollow. Optionally it could be used for storage. A removable bottom cover (not shown) could be latched or interference fit, or more permanently fastened, but removable, for access to the interior storage compartment. The compartment could be used to store, in this example, memorabilia, historical items, valuables, human cremains, or any of a number of things.

As shown in FIGS. 1A-C, base 20 can be ornamented. Two examples are shown. Crossed rifles 42 (e.g. die cast zinc alloy &A-12) are mounted or integral with portion 40 adjacent visor 44. This simulates an actual historical metal pin or cap ornament from the Civil War era. Buttons 46 are placed on opposite sides of the lower part 24 of base 20. They can simulate buttons for a chin strap or can simply be decorative. Indicia such as letters or symbols 48 (e.g. die cast zinc alloy &A-12) can be embossed or engraved or mounted on buttons 46.

Indicia 30 (e.g. stamped, 3-D, embossed aluminum with applied UV inhibitor link) comprises graphics simulating a Civil War era symbol or flag. In this embodiment, indicia 30 is a 0.020″ thick brass or aluminum plate with the graphics of the flag applied to its top surface. In this example a conventional computer-controlled printing process applies ink to the plate in the colors and patterns shown. As can be appreciated, there are a number of known methods of doing so. Optionally whether through printing or through processing there can be three-dimensional features such as embossments or engravements.

Frame 32 (e.g. an engraving plate such as engraveable brass or gold material) is, in this example, a brass ring (e.g. a polished metal stamping) formed to have an outer perimeter which is complementary to the top 26 of base 20. It can be configured to lay over plate 30 and by gravity hold plate 30 in place on top of base 20. It is capable of being engraved with the indicia (not shown). One example would be dates, names, events that can be placed on the top surface 36 of ring 32 or on the side edge of ring 32. In this example buttons or bosses 38 are shown which further add decoratively to ring 32. Other decorative features, of course, are possible.

Alternatively, screws or other fasteners could be used to more robustly attach frame 32 to base 20 and clamp plate 30 in place. It could also be complementary male and female relationships between frame 32 and base 20 to hold them together. In one example, a single screw or pin might be used to add security to that attachment. A variety of ways are possible.

Base 20 can be die-cast aluminum (e.g. A380 aluminum). Another example is die-cast zinc alloy. It can be made of one piece or several pieces. Portions of it can be painted or textured differently than others.

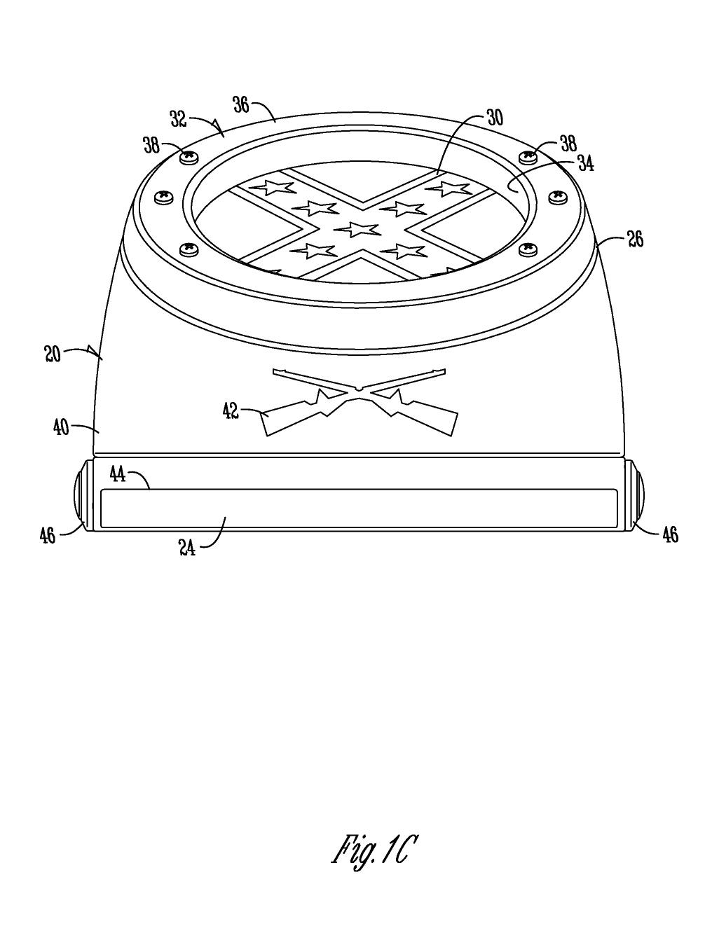

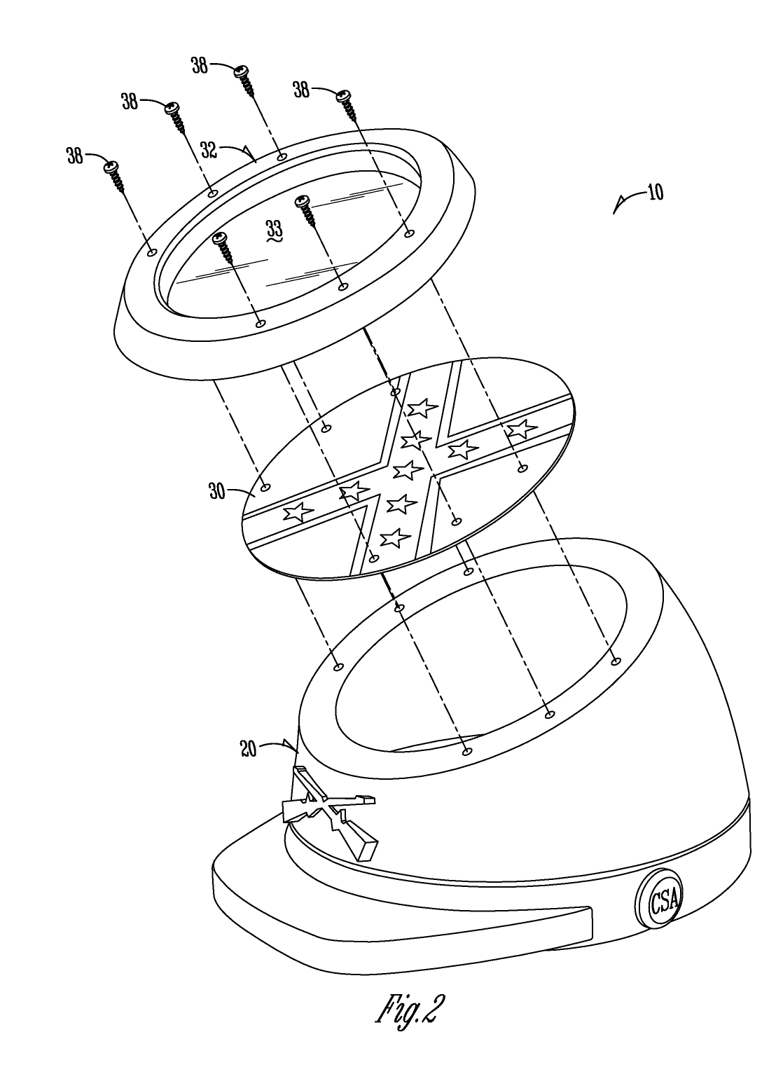

This arrangement presents convenient viewing of the indicia on plate 30 when apparatus 10 is placed on a horizontal surface. Robustness of plate 30 and the indicia on it does not require a lens or window pane over it. Optionally, however, such could be used (see pane 33, FIG. 2).

As can be well appreciated, the indicia that is printed or mounted on plate 30 can take any of a wide variety of forms. It could be a Union flag symbol, a coat of arms, or other Civil War related symbol. Alternatively, it could be text. It could even be more pictorial images including photographic type images. It could be any image, graphic, or indicia desired.

On the other hand, there could be fabric, paper, or other materials including actual items placed for display. Another example would be a clock or timepiece that is functioning.

### Options and Alternatives

The exemplary embodiment above is by way of example only and not limitation. Variations obvious to those skilled in the art will be included within the invention.

The proportions, materials, and configurations can differ according to design and need. The shape or simulation of an actual object of a base can vary, as can what is displayed on top of the base.

What is claimed is:

1. An apparatus for dual function storage or display comprising:
a. a base, the base formed to evoke or simulate an actual item;
b. an indicia positioned on a top surface of the base, the indicia related to the item evoked or simulated by the base.

2. The apparatus of claim 1 further comprising a display area built into the base including a cover with a window that is removable from the base.

3. The apparatus of claim 1 wherein the base comprises a rigid material.

4. The apparatus of claim 1 wherein the base comprises a bottom surface adapted to mount to a table.

5. The apparatus of claim 4 wherein the top surface is at an angle oblique to the bottom surface.

6. The apparatus of claim 1 further comprising one or more decorative elements arranged on the base.

7. The apparatus of claim 6 wherein the decorative elements are consistant with the actual item evoked or simulated by the base form.

8. The apparatus of claim 1 wherein the base is hollow.

9. The apparatus of claim 8 wherein the top surface is openable to provide access to the interior of the base.

10. The apparatus of claim 1 wherein the base is formed to resemble a kepi hat.

11. The apparatus of claim 10 wherein the base is formed from rigid material.

12. The apparatus of claim 11 wherein the indicia comprises a Civil War era flag.

13. The apparatus of claim 11 wherein the civil war era flag is a Confederate battle flag.

14. The apparatus of claim 13 further comprising decorative elements designed and positioned on the base consistant with Civil War era Confederate kepi hats.

15. An apparatus for storage or display comprising:
a base having a bottom surface adapted to engage a table and a top surface at an angle oblique to the bottom surface, the base formed of rigid material and evoking or suggesting a Civil War era kepi hat;
a decorative display on the top surface;
a window mounted over the top surface to protect the decorative display.

16. The apparatus of claim 15 wherein the base is hollow, defining an interior space.

17. The apparatus of claim 16 wherein the top is openable to provide access to the interior space.

18. The apparatus of claim 17 wherein the decorative display is a Civil War era image.

19. The apparatus of claim 18 wherein the Civil War era image is a Confederate battle flag.

20. An apparatus for storage or display comprising:
a base formed of rigid materials comprising a bottom, a top, and a side surface therebetween, the top at an angle oblique to the bottom;
a cavity in the base bounded by the bottom and side surface; and
a hinge connected to the top and side surface, the hinge allowing selective access to the cavity;
a display surface on the top;
wherein the display surface comprises a Confederate battle flag and the base is formed to resemble a Civil War era kepi hat.
